(19) United States
(12) Patent Application Publication
(10) Pub. No.: US 2005/0044971 A1
(43) Pub. Date: Mar. 3, 2005

(54) Motor driven sampling apparatus for material collection

(76) Inventor: Joel Steven Harris, Gloucester (CA)

Correspondence Address: Joel S. Harris, 6073 Valley Field Cres., Gloucester, ON, K1C 5P3, CA

(21) Appl. No.: 10/652,302

(22) Filed: Sep. 2, 2003

(51) Int. Cl. G01N 1/04

(52) U.S. Cl. 73/864.43; 73/864.41

(57) ABSTRACT

An apparatus to excise a sample of material and temporarily store sample has a tubular clamshell casing at an angle to the horizontal, blended to a tubular boss under which is a tubular sample sleeve extending downwards from the boss. Within the casing an electric motor is housed which drives, via gears, the sample sleeve in a rotational manner. The end of the sleeve, distal from the boss, forms a cutting edge circumscribing a circular region. An ejection rod slides reciprocally within the sample sleeve between a stowed position and an expulsion position. When the ejection rod moves from the stowed position to the expulsion position, it will extend past the cutting edge and expel any sample of material contained within the cutting sleeve. A user cuts a sample from a source material using the cutting blade of the apparatus when the ejection rod is in the stowed position. The sample is cut when the cutting blade engages contact against the sample and gentle downward pressure is applied while a finger trigger activates the electric drive to rotate the cutting sleeve. Alternately a user may cut a sample from a source material by engaging contact between the cutting edge of the tubular sleeve and the source material, applying downward pressure against the source material thereby activating the electric drive to rotate the tubular cutting sleeve. Once the source material has been cut it is simultaneously extracted and lodged within the tubular sleeve. The extracted sample remains lodged in the tip of the tubular cutting sleeve until the user actuates the ejection rod through the sleeve to the expulsion position to eject the sample of source material. Return actuation of the eject rod is comprised of a coil spring that biases the rod in the retracted stowed position.

### BACKGROUND OF THE INVENTION

1. Field of Invention

Micro-sampling devices are conventionally used to slice/cut, scoop, punch or bore samples from source materials such as paper, cloth, wood, gels, human and animal tissues and the like. The samples collected may undergo wet chemical treatment; may be examined microscopically, used to create tissue micro-array slides, or be further chemically analyzed by a variety of analytical equipment including pyrolysis gas chromatographs, mass spectrometers, scanning electron microscopes and Fourier infrared spectrometers.

A widely available and commonly used micro-sampling tool is the garden variety paper punch. These tools are manually operated and available a craft stores or business supply outlets. They have been routinely used to sample dried blood stored on blood cards or for sampling leaves in the study of crop genetic events. There are also dedicated, electric, automated punches, with large footprints designed for high throughput sampling. These systems require the user to manually feed a blood card which, when punched, automatically delivers the sample to an extraction vial, well plate, or other receptacle. These systems are designed for punching dried blood on archival blood cards only.

Paper sampling is used in the neonatal, forensic and genomic markets to analyze blood for a variety of components. Blood samples are collected on filter paper cards and then allowed to dry. A small disc of paper bearing blood is then punched from the card. The blood may then be analyzed for genetic events, diseases, proteins, enzymes or other specific component.

Typically punches are constructed of a punch and dye. When operated they create a shearing action thereby tearing the disc of paper from the source card. Writing bond paper is lighter and therefore thinner and a more tightly woven product than filter type papers (i.e. coffee filter papers for example). With lighter bond papers, the shearing action of the punch and die during the punching operation creates little or no artefact fibres. This paper however, does not have the desired absorbent quality required to store blood. Blood samples and other related body fluids (i.e. saliva) are stored on thicker filter paper. This type of paper product is characterized by a loose fibre matrix. Therefore the punch/die shearing operation when punching a sample from such paper will result in the creation of associated artefact fibres. When punching filter paper bearing blood paper fibre artefacts bearing blood will be generated which may be transferred to the next sample punched and into the collection vial receiving the sample. Therefore conventional paper punching systems when used to sample blood cards generate artefacts which may lead to cross contamination.

Bench top, large footprint, automated electric punches have several moving parts both associated with the punching mechanism and the x-y translational stage holding plates or racks of vials below the dye. With high throughput these system generate static. The artefact fibres that are created may be controlled under certain condition (i.e. de-ionization or other anti-static devices) or the sample may be randomly distributed and not delivered to the desired location. With increased usage static can build quickly and result in artefacts becoming airborne, resulting in carry over and cross contamination. The static may affect delivery of the punched disc down the delivery column resulting in non-delivery, sticking or delivery with a subsequently punched sample doubling up in a single vial.

The racks to receive the samples on the automated punches are positioned below a platen on which the paper sample is positioned for punching. Therefore the operator has no line of sight to confirm that the sample punched has been delivered to the correct vial and whether cross contamination has occurred.

Manual punches, if used for high throughput sampling of blood cards in place of more expensive automated systems, may result in repetitive stress injuries (RSI) over time to the wrist.

This new invention offers a combination of unique features including:
An electric motorized coring operation thereby reducing repetitive stress associated with manual punching devices;
A coring mechanism and not a punch and dye punching mechanism, eliminating the creation of paper fibre artefacts and associated cross contamination;
An absence of static build up, a contributing factor to potential cross contamination and carry over of artefacts to other samples or vials;
A completely open line of sight concept insuring sampling of the desired target area and correct delivery to the preferred vial location;
Increased sampling diameters made possible by a plurality of cutting sleeves and can be quickly exchanged;
A simultaneous cutting, lifting and storage of the sample from the source material;
Absence of repetitive stress injury (RSI) associated with manual punches;
Rapid change of sampling tips and tip diameters; and,
Increased throughput without a corresponding increase in the size of the unit.

2. Description of Prior Art

Paper punches, such as the Fiskars® crafters punch or other single hole stationary punches are widely available. These punches are inexpensive to purchase, simple to operate and offer a range in punch/die diameters from 1/16th inch to 1/4 inch. The sample may be carefully punched from specific source materials such as paper and the sample delivered directly into the collection well or easily collected after punching with the aid of a tweezers or other forceps, and then inserted into the extraction vial. These manual punches generate little or no static compared with large automated electric punches. However, there are several limitations which make these devices a less than desirable tool for extracting dried blood samples from blood cards.

Paper punches are constructed with the punch and dye open and not in contact. This is maintained by a biasing spring mechanism. This allows samples blood cards, within a limited ranges of thicknesses, to be quickly and easily inserted into the punch throat for punching. The area of interest to be punched can be quickly positioned below the base of the punch. The punch may be operated in one hand with the other hand used to hold the source card. This is a suitable method of sample extraction for low sampling programs where the source sample is of suitable thickness and surface dimension.

The punching action for this type of punch occurs when the top and bottom levers are squeezed together in one hand, using the thumb on top and the remaining fingers below. Due to the tension of the spring this operation can create fatigue in the finger, hand and wrist muscles after only a few sample punches are produced, and increase in fatigue over a lengthier period of repetitive punching. Therefore repetitive stress injury may develop quickly with this type of punch where even the smallest sampling pools to be collected become an arduous and painful task.

While the punch and die on this unit remain open at all times allowing for quick insertion of source material for sampling, the vertical height of the throat between the punch and die on these punches may not be large enough to handle some blood cards of greater thickness, or versatile to sample other materials soft enough to be sampled with this instrument but too thick to be inserted.

Another problem with these punches is that the horizontal length of the throat is limited and therefore may restrict sampling over all surface areas and locations of a particular blood card. For example, the Whatman GeneCard requires sampling with a 7.0 mm punch. The description of use states that sample can be collected almost from the center of the card. Sampling directly from the center of the card is not possible with a conventional paper punch because the horizontal throat of the punch is less than the distance from the edge of the card to the centre of the card. Therefore this type of punch is limited to sampling blood cards with surface dimensions that ensure the card can be inserted to allow the punch to reach any location on the surface where the blood may have dried.

These punches use a punch dye mechanism and therefore cut samples by shearing a sample from the source material. The punch pushes the sample through the die, essentially tearing rather than cutting the sample disc. This may generate artefact fibres over time with repeated sampling of fibrous blood cards. If the die and surrounding area on the punch is left uncleaned or uncleared between samples, then these artefacts may build up and result in carry over to the next blood card and subsequently be deposited with the next sample into the extraction vial. Therefore this type of punching device lends itself to cross contamination. These types of punches are restricted in their application to primarily sampling blood cards and cannot suitably sample gels, tissue or other soft substrates. These punches have also been used in the agrosciences to study genetic events in crops such as corn, cotton, sunflower and soya plants. The leaf is inserted in the punch throat similar to a blood card. However, with crop studies, sampling from a single leaf may range from 1 to as many as 12 samples. Because plants have a liquid component in the leaves, repeated sampling allows for a build up of plant saps which cause samples to adhere to the punch and are not easily transferred down the die.

The paper punch is a very common, inexpensive sampling tool for sampling dried blood on blood cards and some other flat samples such as leaves.

Another manual paper sampling device, also inexpensive and widely available is the Harris Uni-Core (U.S. Patent Application No. 20020164272). This tool is constructed of a plastic barrel handle, a stainless steel sharpened coring tip and a spring operated ejection actuator. These coring tools are available in inside diameters ranging from 0.50 to 8.00 mm. There is no lever operation and therefore no throat. This allows such tools to sample from any location on a blood card. However, since there is no punch and die mechanism the sample must rest on a pliable support. The stainless steel end of the coring tool is pushed with one hand into the blood card, leaf sample, gel, paint chip, plastic, etc. with slight rotation and gentle downward pressure. The stainless steel tip may also be used to create custom size micro-filters from large samples of filter paper. The sharpened tip passes through the card and into the pliable under support. The cored sample is retained in the tip where it can be later ejected using the actuator.

Because of the razor sharp cutting tip and absence of lever action, repetitive stress on the hand occurs less frequently over the same sampling period when compared with sampling with a craft paper punch. However, the Uni-Core is still not suited for high throughput as repetitive stress injury will develop with prolonged use. The nature of the cutting tip allows this instrument to be used for sampling a variety of materials including gels, paint chips, food, etc., and to create custom size paper filters. This is a versatile sampling tool that can be used on a variety of samples of any surface dimension enabling sampling from any location without restriction in size or thickness.

Both the paper punch and Harris Uni-Core are manual punches and are not designed to punch or core a sample directly into a collection vial, however, the paper punch can accomplish this but not with consistent speed and repetition.

A third example of prior art is from IEM Screening Systems (Division of Fundamental Products Company). This company produces both manually operated and electric automated punching systems. The manually operated system consists of a punch which can hold a specific 96 hole blood card and a plastic 96-hole plate directly below the card. The punch automatically moves each time a sample is punched. Each sample is purportedly punched into a collection well in the plastic micro-titre plate located directly below and in registration with the paper blood card. However, delivery of sample is not visible to the operator and therefore cannot be confirmed after each operation. The sample is manually punched and drops directly into a specific extraction vial. Because of the lever action there is less associated repetitive stress injury than with the former two prior art examples, but RSI can occur with prolonged use. Again a punch and dye mechanism is used and this can create artefacts and lead to cross contamination. These punches may only be used with specific cards of a corresponding horizontal surface dimension equaling that of the plate. The sample can only be punched from the center of the printed circle on the card where the blood sample has been entered. If the sample is not centre than the punch head will miss the sample. Therefore this punch mechanism requires sample cards prepared in a specific manner to ensure all sample can be reached for punching. This system is also restricted to sampling 96-spot blood cards and only samples with thicknesses equivalent to blood cards. There are similar restriction on this sampling tool when compared with the Harris Uni-Core.

These former examples of prior art, while functional, are not suited for high throughput sampling regimes, and, with the exception of the Harris Uni-Core, may only be used with blood cards of a limited surface area and thickness. The Harris Uni-Core may be used on samples of a variety of thicknesses and horizontal surface areas.

Neonatal testing of newborns and paternity testing, as well as other large routine blood sampling programs, have necessitated the development of automated punching systems to handle large volumes of blood cards.

Several automated punching systems are available from BSD Technologies (Australia), EMI (USA), Nanometrics (USA), Biorad (USA) and Wallac (USA), Harris Multi-Punch (Canada). Each of these systems operates on a punch and dye mechanism and is designed to punch a single, and sometimes two samples in rapid succession from the same blood card. These systems are only designed to sample blood cards and no other source material.

The sample must be hand fed into the punching region on the automated systems. At this point the punch may be activated with a foot pedal or by pressing a platen upon which the card rests below the punch. Depressing the platen activates the punch.

A plate of uniform footprint but with varying number of holes is positioned below the dye on the punch. After punching, the sample drops down a column into a collection well in the plate. As the next sample is positioned to be punched the plate below the punch/die is automatically moved in the horizontal plane to position the next open well to receive the next punched sample. There are no hopper feeding systems for automated feeding of cards, and therefore each card must be inserted manually. This may create a safety issue as one or both hands may be used and therefore places the operators fingers in the vicinity of the punch. If the operation is not synchronized, the pedal or platen activation may result in operator injury.

The automated punches create static, particularly under dry conditions often encountered during the drier winter months. This may affect delivery of the sample down the delivery column. As well these systems can create artefact fibres due once again to the shearing action of the punch and die which tears the sample. This may result in fibres becoming entangled with samples due to static build up and may lead to cross contamination.

The throat of these units is larger than that for the manual punches, except for the Harris Uni-Core. The thickness may also duplicate that used for paper punches but is not unlimited as is the case with the Harris Uni-Core. These systems offer increased through put but may not offer the expected confidence that the samples generated are always delivered where expected nor that there is no cross contamination occurring between subsequent samplings. Contamination becomes a chronic condition of these sampling tools which is not always easy to monitor nor are the systems designed to monitor the creation and dispersion of such artefacts.

The new invention combines several features in the prior art. The new invention continues to use the same sharpened coring tip that is used on the Harris Uni-Core. This ensures that a sample from the source material is cut and not sheared or torn, and therefore does not generate artefact contaminant fibres. The new invention is electric and a motor turns the coring tip. This is now a semi-automatic system similar to the electric punching units mentioned in the prior art. However, because there is no punching and therefore fewer moving parts in contact there is little or not static created. Therefore the new invention is electric but does not generate the associated static characteristic of the larger electric automated punching systems. The motorized coring operation eliminates the need to rotate the coring barrel as is required on the Harris Uni-Core. Therefore there is reduced RSI. The unit can be operated in one hand thereby allowing the sample to be positioned, similar to the automated systems. However, the new invention is not a punch and therefore the sample is not directed into an unseen collection vial or well. Instead the sample is retained in the coring tip as occurs with the prior art Harris Uni-Core. The sample may now be directed into a well or vial and the operator can visually confirm delivery, which is not possible on the prior art automated punching systems. As the new invention is electric it is designed to allow the operator to process more cards with minimal RSI. As the new invention uses a coring tip and is not restricted by a throat as occurs on stationary paper punches, the new invention may sample any location on samples of unlimited surface size. The tips are disposable and can be easily replaced which is not possible with the prior art manual or automated punching systems. This new invention is designed to further reduce RSI by being contoured to be held in a familiar position in the hand similar to holding a writing instrument.

The distal sharpened edge of the tubular cutting sleeve passes through the source material and cuts into the backing support. This operation in combination with the backing support, forces the extracted sample to be subsequently lodged in the distal end of the tubular cutting sleeve. The sample is then dislodged from temporary storage by forcing it out with an ejection plunger.

There are disadvantages with the prior art coring tools, most notably the susceptibility of the operator to Repetitive Stress Injury (RSI) and more specifically Carpal Tunnel Syndrome (CTS), a condition which interferes with the use of the hand and is caused when too much pressure is put on the nerve that runs through the wrist. Even minimal use of the manual coring device over short periods of time has lead to reported wrist discomfort. This discomfort is acerbated when the manual coring device is used in high throughput sampling environments requiring extended daily use by a single operator. The mild, periodic discomfort may lead to more chronic pain such as arthritis. The operation of the manual coring tool requires finger griping, downward vertical wrist pressure and repeated lateral turning of the wrist in a semi clockwise/counterclockwise direction.

The new invention incorporates the original unique properties of the prior art manual coring tool but has been ergonomically designed to reduce and/or eliminate RSI and CTS. The tubular cutting tip is operated from an electric drive, rotating the tubular cutting sleeve thereby eliminating lateral rotation of the wrist. The wrist does not become fatigued and sore thereby increasing continual use of the instrument. The wrist remains in the preferred neutral straight position when operating the motor driven coring device. Vertical downward motion translation is minimal as the design of this new invention places the cutting edge of the tubular cutting tip in close proximity to the surface of the source material to be sampled. The rotation of the cutting sleeve by the electric motor eliminates the required downward pressure as the sharp edge of the tubular cutting sleeve cuts into the source material on minimal contact. The tubular handle at an angle to the horizontal is designed to rest in the fork (or bridge) of the hand between the thumb and index finger similar to holding a large diameter pen or felt tip marking instrument. The vertical blended tubular boss may be gripped with the entire hand and not just the fingers thereby further reducing conditions that give rise to RSI and CTS. The rotation of the tubular cutting sleeve is driven by two angularly placed mitre gears. The use of these gears reduces the speed of rotation of the motor to a rotational speed approaching that used on the manual coring tool. A second advantage of the reduction in speed is that it also reduces torque generated by the motor and therefore associated vibration which may be translated to the hand and wrist and represent another contributor to Carpal Tunnel Syndrome. The electric driven tubular cutting sleeve offers the necessary means to conduct high throughput sampling over extended daily periods with minimal or no development of RSI. This high throughput is synonymous with that expected from the electric punch devices discussed earlier. The sharp edge of the tubular cutting sleeve combined with the motor driven rotation of the tubular cutting sleeve reduces the required downward pressure commonly needed and applied when using the manual coring tool. The motor driven cutting sleeve may also allow for cutting of thicker substrate materials without the required downward pressure used with the manual coring tool.

In this new invention, as with the prior art, the sample sleeve serves both as a cutting tool and as a temporary storage receptacle to retain the sample. The sample ejection system enables quick, safe and clean removal of the sample from the cutting sleeve either in a rapid action for quick throughput into a collection vial, or more slowly, to position sample on a sampling stage. The electric drive minimizes manual exertion and the angle and diameter of the tubular handle and blended boss are ergonomically designed to fit the hand. Sample sleeves are held in the drive boss with a collet system so as to be easily removable for size changes or sterilization. Similarly the ejection rod may also be removed and replaced for different corresponding diameter cutting sleeves and also periodic cleaning as required.

This motor driven sampling device was designed for high throughput sampling of dried blood on blood cards or sampling of any other material on media or in situ. Prior art describes a manually operated coring tool which requires finger, hand and wrist movement to core a sample. When used in high throughput sampling regimes this can, and does, lead to repetitive stress injury (RSI). This new electric coring tool has been ergonomically designed to reduce and eliminate RSI from occurring as a result of long term repeated coring operations. The tool rests in the bridge of the hand between the thumb and first finger similar to holding a pen. The thumb, second finger and palm of the hand hold the blended boss while the index finger operates the trigger mechanism and ejection plunger.

The hollow tip on this new invention allows for the collection of many samples unlike that of the automated punching system.

Although electric, there is reduced torque produced as a result of angular mitre gears resulting in a gearing down of the motor rotation. This results in little or no vibration of the motor and no translation of generated vibration to the hand, thereby again reducing CTS. It is the combined ergonomic design and electric rotating tubular cutting sleeve which makes this new invention safe, RSI and CTS stress free and effective in high throughput sampling regimes.

Replacement of cutting tips is realized by insertion of a dead jack (without current) into the socket at the distal end of the tubular handle opposite the end where the blended tubular boss forms. By depressing the trigger on the blended boss, the armature coil of the motor is shorted. The armature in the motor is therefore transformed into behaving as a generator/dynamo, therefore developing resistance. This results in braking allowing the collet nut to be loosened for replacement of cutting tips. An alternative method of tip replacement employs a spindle lock button which is depressed therefore locking the collet spindle allowing collet nut to be loosened and the collet removed to replace the tubular cutting tip.

A search did not disclose any prior art electric coring tools for sample collecting. One reference refers to a prior patent application for a manual coring tool (Harris). A second patent refers to a battery operated coring tool for coring vegetables and fruits (Dolah).

Canadian Patent Application
2,345,911 Harris

United States
U.S. Pat. No. 5,852,875 Dolah

### SUMMARY OF INVENTION

The present invention is an electric sample cutting and collection apparatus comprising a tubular clamshell casing at an angle to the horizontal, blended to a tubular boss under which is a sample sleeve extending downwards from the boss. Within the clamshell casing an electric motor is housed which drives, via gears, the sample sleeve in a rotational manner. The end of the sleeve, distal from the boss, forms a cutting edge circumscribing a circular region. An ejection rod slides reciprocally within the sample sleeve between a retracted stowed position and an expulsion position. A user cuts a sample from a source material by engaging contact between the cutting edge of the sample sleeve and the source material, applying pressure against the sample and activating the electric drive to rotate the cutting edge. The electric drive may be activated either by downward pressure and contact with the source material or through a push button trigger on the side of the blended boss. The sample cut from the source material is then lodged within the tubular cutting sleeve. Actuation of the eject rod from the retracted stowed position toward the expulsion position displaces the sample from the sleeve into an appropriate collecting vessel. Return actuation of the eject rod is comprised of a coil spring that biases the rod in the retracted stowed position. Samples may be collected in situ or on a cutting mat support. The unit is designed to be held in the hand rather like a wide writing marker, with the centre of gravity of the barrel balanced in the fork between the thumb and the first finger. The blended boss is grasped with the thumb and fingers resting on protruding finger and thumb rest ledges molded into the clamshell casing which can receive downward pressure. The unit may be operated with either hand. The device is designed to receive the hand at a natural angle thereby reducing stress and avoids using the wrist in a bent (flexed), extended, or twisted position for long periods of time. Instead, the ergonomic design of the punch allows the wrist to maintain a neutral (straight) position. The whole hand is used to grasp the object thereby avoiding gripping and lifting with thumb and index finger which can add stress to wrist. The device is not handed, thus equally usable in a one-handed manner by either hand. The unit has been sculpted to complement the contours of the human hand.

In this invention, the sample sleeve serves both as a cutting tool and as a temporary storage receptacle to retain the sample. The sample ejection system enables quick, safe and clean removal of the sample from the tubular cutting sleeve. The electric drive eliminates manual exertion by eliminating the need to rotate the hand in a semi-clockwise and counterclockwise manner to core a sample from the source material. Eliminating the wrist action in this new invention allows for the operation of the device with the wrist in the neutral or straight position, eliminating stress to the hand. This new invention has also been ergonomically designed to simulate a large diameter pen or felt tip marking instrument. This has resulted in a ergonomic fit of this invention to the hand comfortably resting in the fork or bridge area between the thumb and index finger. The internal drive utilizes two angularly placed mitre gears which reduce torque and therefore minimize transfer of motor vibration to the hand, reducing another contributor to hand strain. The blended tubular boss is held by the entire hand and not the fingers, again reducing another contributing source of wrist and hand stress.

This invention may use a plurality of tubular cutting sleeves of different diameter and length. These cutting sleeves are held in the distal end of the tubular blended boss by a collet system accessible by loosening a collet nut. This collet nut allows easy removal of the tubular cutting sleeves for cleaning, replacement or exchange of size.

The addition of a motor to rotate the cutting sleeve, the low torque on the motor, together with the ergonomic design of the tool, eliminates repetitive stress related injury resulting from prior art manual coring and punching devices. The electric motor used to rotate the cutting sleeve eliminates the turning of the wrist required for the Harris Uni-Core. The angle from the horizontal of the tubular handle allows the coring tool to rest comfortably on the bridge of the hand between the thumb and index finger much like a writing instrument. This is a position all persons who use a writing instrument are familiar with, thereby making this coring design less foreign when initially used and more accepted to the hand. The position of the activation trigger can be easily operated with minimal stress on the hand. The low torque of the motor results in minimal noticeable vibration transfer to the hand resulting in less stress on the hand.

The motorized rotation of the cutting sleeve and ergonomic design allow for repeated sampling with minimal strain on the hand and increased sampling range as the system is capable of sampling a wider variety of substrates of difference thicknesses over longer periods of time. The tool is designed to accommodate different diameter cutting sleeves and ejection rods.

The collet system, which holds the tubular cutting sleeves, can be removed from the tubular blended boss by a spindle lock mechanism. An alternative is the insertion of a dead jack accessory into the distal socket to short the motor armature causing a braking action. In either case the collet nut can be removed for subsequent removal of the tubular cutting sleeves from the collet for cleaning of the tips, ejector rod or replacement of the tip and/or ejector rods.

The combined locations of the trigger and ejection rod buttons free one hand to position a sample, hold sample over cutting support and acquire collecting vessel for ejection of sample, while the other hand operates the cutting device.

This device may be used optionally in conjunction with a cutting support upon which the sample is positioned.

The present invention allows the user to portion appropriate size samples from source materials such as food, plants, agricultural materials, gels, clothing, paint chips, film, paper, human or animal tissue and substrates bearing materials to be sampled such as ink on paper, blood on filter paper, blood on cloth, other biological stains on cloth, etc. This present invention may also be used to create custom size micro-filters from large samples of filter paper. Sampling is accomplished by placing the desired material on the surface of a cutting support and penetrating the material to be sampled with a sharp cutting tool by applying downward pressure, thus the surface of the cutting support is also penetrated but not perforated. These and other advantages of the invention will be more particularly realized by a reading of the following detailed description of the invention together with the drawings in which like reference numerals refer to like parts throughout.

### BRIEF DESCRIPTION OF THE DRAWINGS

FIG. 1A is an elevation side view showing a preferred embodiment of a sample collection apparatus constructed in accordance with the principles of the invention without the spindle lock for removal of the sample collet nut.

FIG. 1B is an elevation side view showing a preferred embodiment of a sample collection apparatus constructed in accordance with the principles of the invention with the spindle lock to remove the sample collet nut.

FIG. 2A is a perspective view of the apparatus of FIG. 1A showing the control buttons (without spindle lock control button on the blended boss).

FIG. 2B is a perspective view of the apparatus of FIG. 1B showing the control buttons (with spindle lock control button on the front of the blended boss).

FIG. 3A is a perspective side view with enlarged detail of the apparatus with the front casing removed, without spindle lock button.

FIG. 3B is a perspective view with enlarged detail of the apparatus with the front casing removed, with spindle lock button.

FIG. 4 is a perspective view with cover removed showing enlarged details of the gears and motor, with spindle lock button for the release of the collet nut.

FIG. 4A is an exploded view of the blended boss with the cover removed in FIG. 4.

FIG. 5 is a perspective view of the apparatus with the tubular coring tip above a blood card resting on a cutting mat, with spindle lock button on vertical boss.

FIG. 6 is a side view of the apparatus with the plunger in the retracted position along section line 1-1.

FIG. 6A is a cross-section view of FIG. 6 along section line 1-1 showing enlarged details of the sample expulsion system in the retracted position, without spindle lock button.

FIG. 6B is a side view of the apparatus with the plunger in the expulsion position along section line 2-2.

FIG. 6C is a cross-section view of FIG. 6B along section line 2-2 showing enlarged details of the sample expulsion system in the expulsion position, without spindle lock mechanism.

FIG. 7 is a side view of the apparatus with the spindle lock button and the plunger in the retracted position along section line 3-3.

FIG. 7A is a cross-section view of FIG. 7 along section line 3-3 showing enlarged details of the sample expulsion system in the retracted position, with spindle lock mechanism.

FIG. 7B is a side view of the apparatus with the spindle lock button and the plunger in the expulsion position along section line 4-4.

FIG. 7C is a cross-section view of FIG. 7B along section line 4-4 showing enlarged details of the sample expulsion system in the expulsion position, with spindle lock mechanism.

FIG. 8 is a perspective of the sample sleeve collet system of the apparatus.

FIG. 8A is a side view of the samples sleeve collet system of the apparatus along section line 5-5.

FIG. 8B is a cross section view of the sample sleeve collet system of the apparatus along section line 5-5 of FIG. 8A.

### DESCRIPTION OF PREFERRED EMBODIMENTS

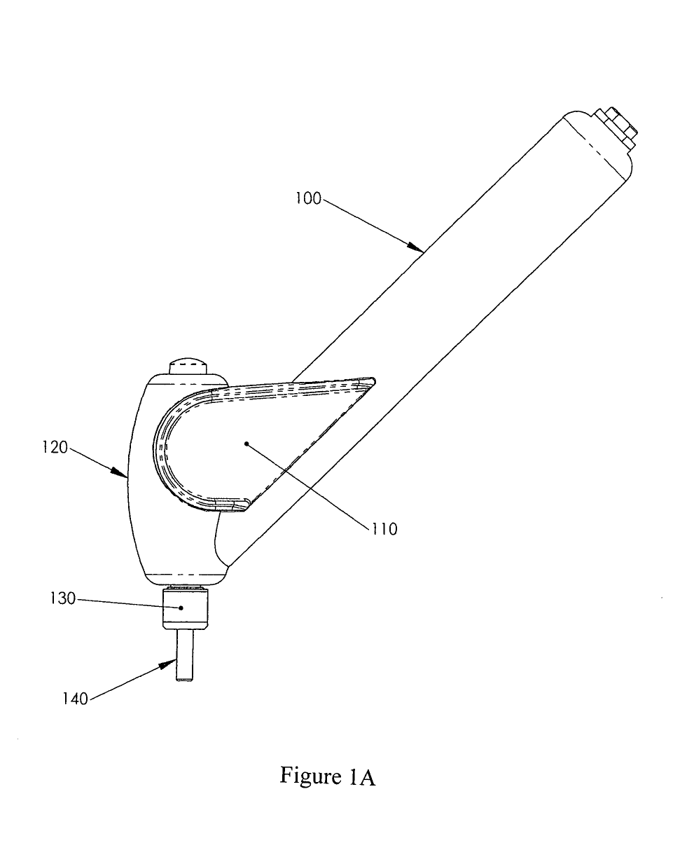

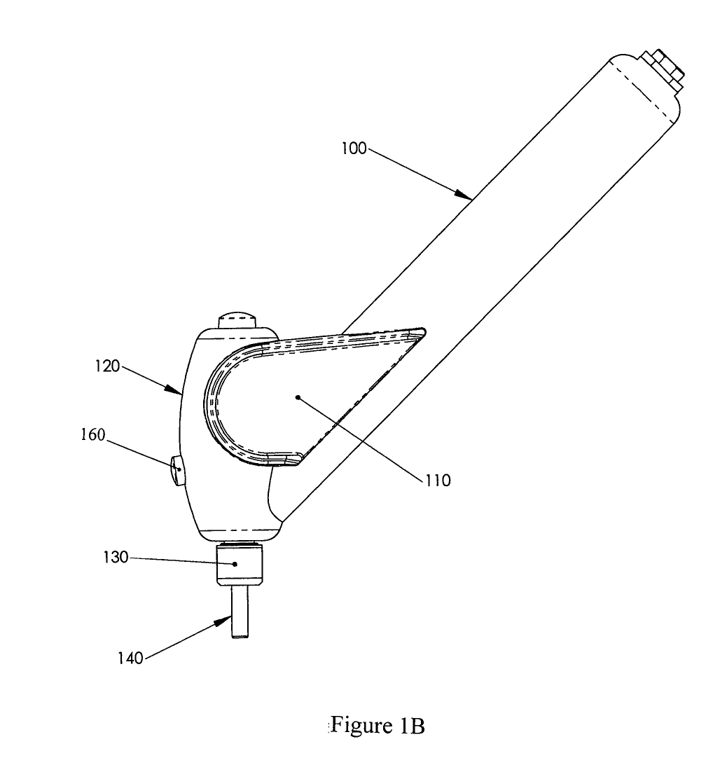

Referring to FIG. 1A, a preferred embodiment of a sample collection device constructed in accordance with the principles of the invention is shown. A tubular handle part 100 blends to a vertical boss part 120 as a clamshell casing. A collet nut 130 at the lower end of the boss holds the tubular cutting sleeve 140. To facilitate ease of holding the unit, finger and thumb gripping rest ledger locations 110 are provided on each side of the casing. The exterior surface of the gripping locations may include a plurality of ridges to provide a better gripping surface for the user. FIG. 1B repeats the preferred embodiments described for FIG. 1A but also shows the clamshell casing with the button control 160 for the spindle lock mechanism on the front of the vertical boss part 120.

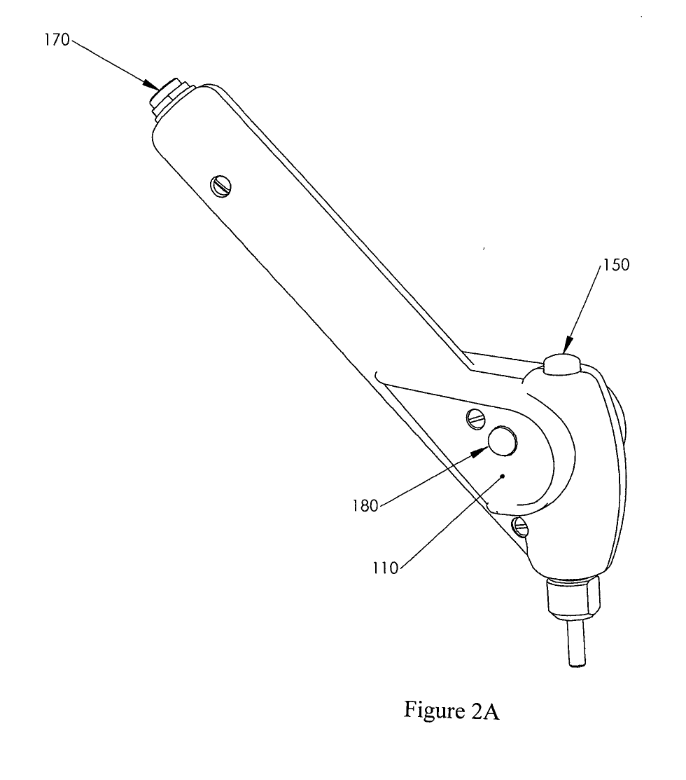

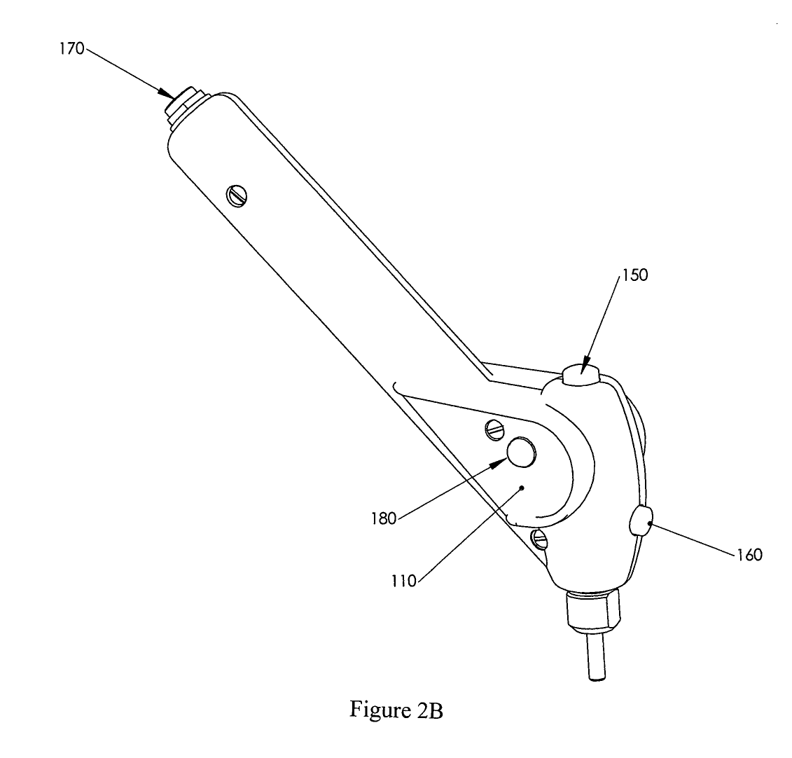

FIG. 2A shows a perspective view of the apparatus. At the upper end of the tubular casing a socket 170 is fitted for electrical supply to the internal drive motor. A push button 150 located at the top of the vertical blended boss and is attached to an eject rod. A push button, momentary type switch 180, activates the motor.

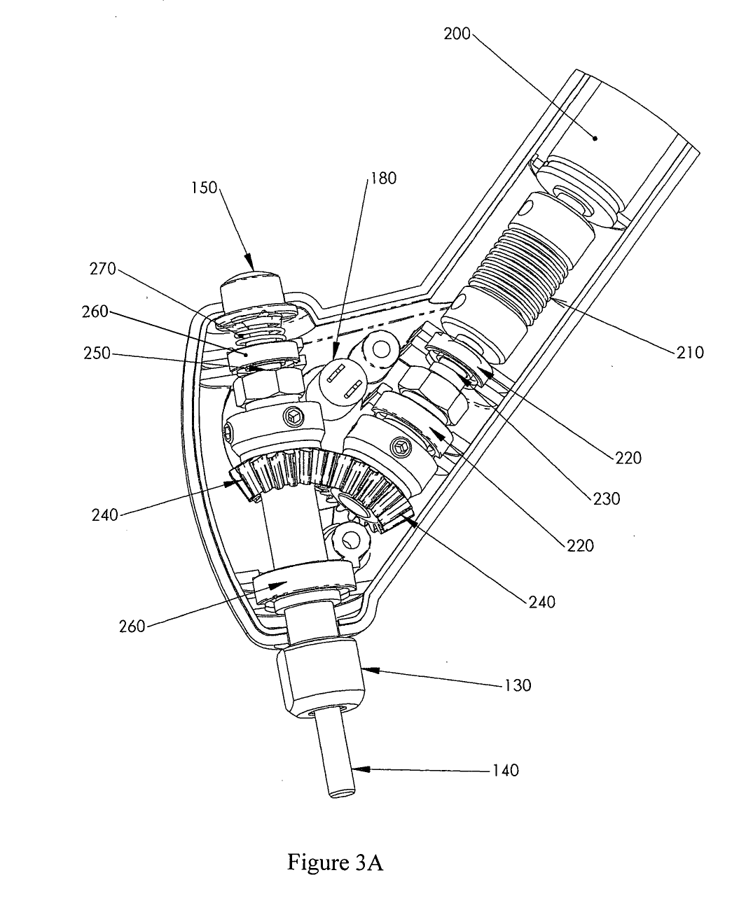

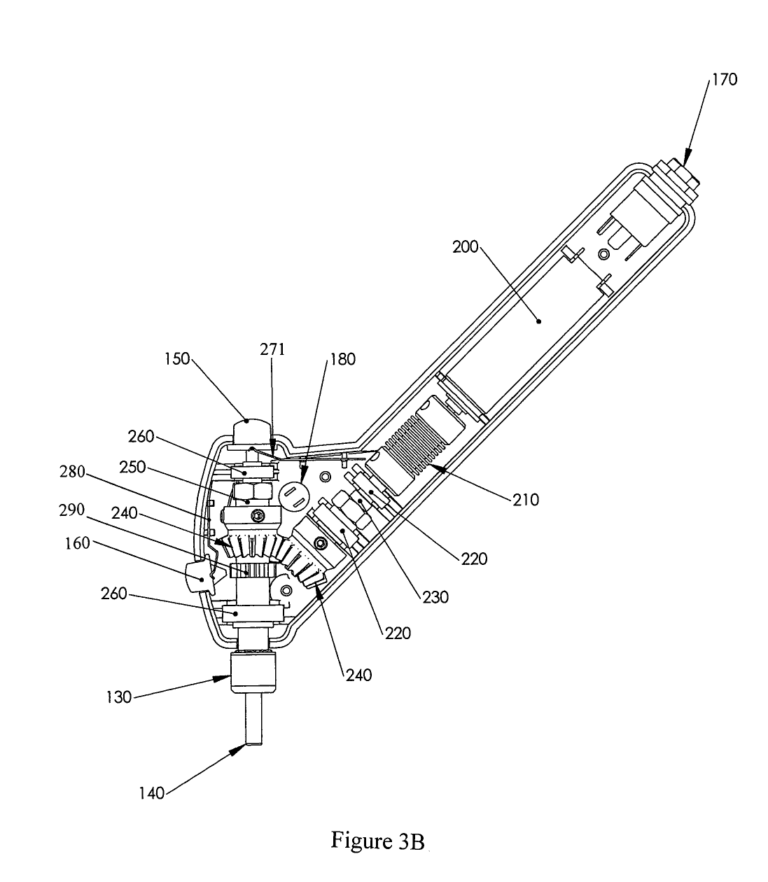

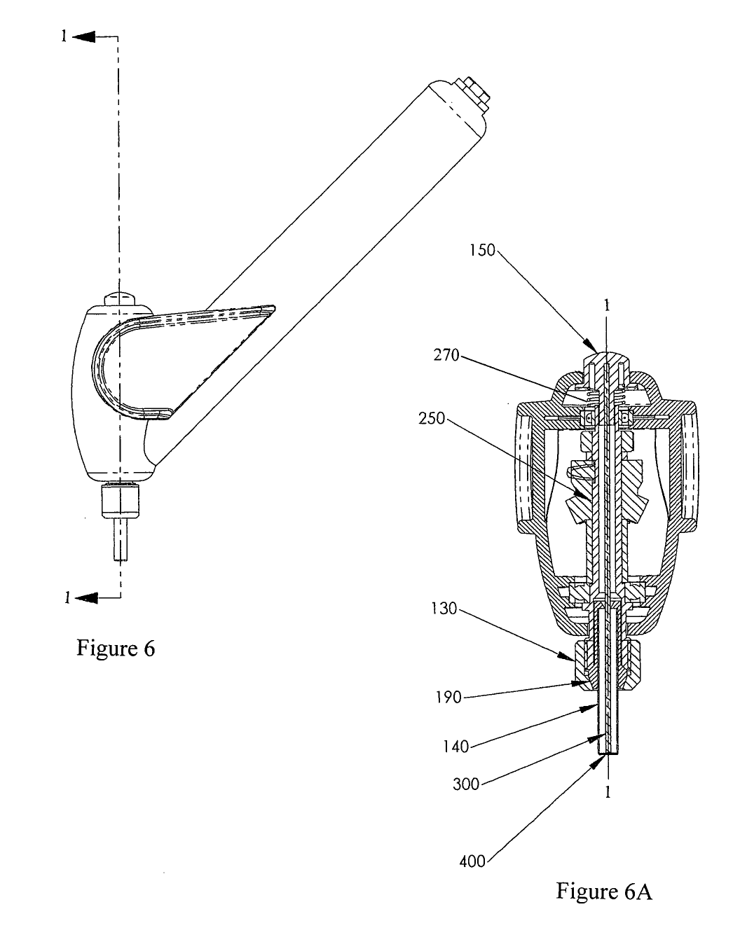

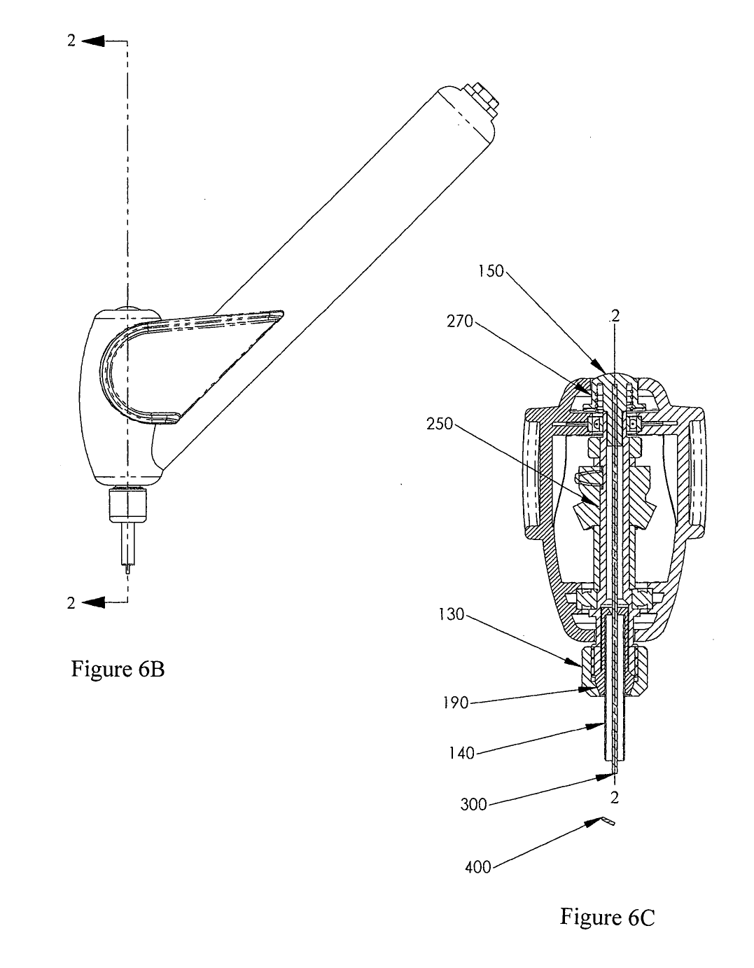

FIG. 2B repeats the preferred embodiments described in FIG. 2A and shows a push button 160 attached to the spindle lock mechanism which may be depressed for locking the collet spindle 250 by way of a leaf spring 280 (See FIG. 3B). When the push button 160 is depressed, its conical nose is inserted between two teeth which are part of a plurality of teeth 290 radially disposed around the circumference of spindle collet 190 (See FIG. 6A). This facilitates loosening of the collet nut 130 and releasing the tubular cutting sleeve 140 for cleaning or changing the sleeve size. Tubular cutting sleeve 140 with a plurality of diameters can be fitted into the collet 190 (See FIG. 6A).

FIG. 3A is a front perspective view with the front casing removed to reveal the drive system. A low voltage geared electric motor 200 is connected via an alignment coupling 210 to a drive shaft 230 that is located between two bearings 220. Electrical power is provided to the motor from the socket 170 (see FIG. 3B) via the switch 180. An angular mitre gear 240 is fastened at the end of the drive shaft in position to mesh with another such gear 240 on the collet spindle 250. The use of angular mitre gears 240 in this embodiment enables the tubular clamshell casing 100 and 120 to be in an ergonomically suitable angle for the hand to hold the unit above the sample being cut. The spindle 250 is located between two bearings 260. The upper of these bearings is sized to ensure correct radial alignment of the spindle and the lower one is sized to suit the axial forces presented during sample cutting. The lower end of the spindle 250 holds the sample collet 190. The sample ejection system is shown in the retracted position with a coil spring 270 biasing the eject button 150 towards the upper part of the casing.

FIG. 3B repeats the preferred embodiments described in FIG. 3A and also discloses the push button 160 for the spindle lock mechanism, the leaf spring 280, and the plurality of teeth 290 deposed around the spindle sleeve. In FIG. 3A the coil spring 270 for biasing the eject button 150 towards the upper part of the casing is shown in FIG. 3B with an alternative leaf spring 271 which also biases the eject button 150 towards the upper part of the casing.

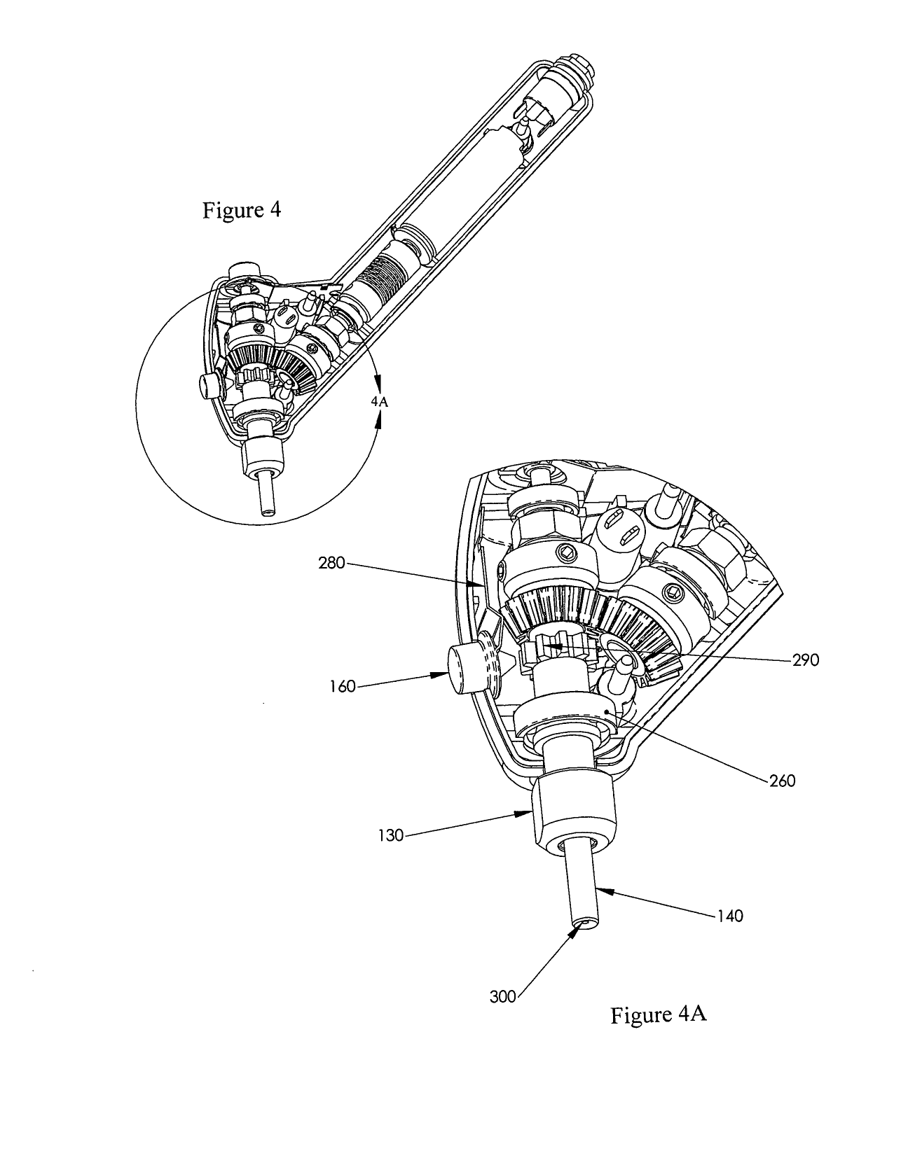

FIG. 4 is a perspective view of the apparatus with the front casing removed to show internal details. FIG. 4A is an exploded version of FIG. 4 describing an enlarged view of the spindle lock mechanism showing the push button 160, which is biased towards the casing 120 by leaf spring 280. When push button 160 is depressed, its conical nose is inserted between two of a plurality of teeth radially disposed around the circumference of spindle sleeve 290. This effectively prevents the spindle 250 from rotating while the collet nut 130 is slackened or tightened as described above.

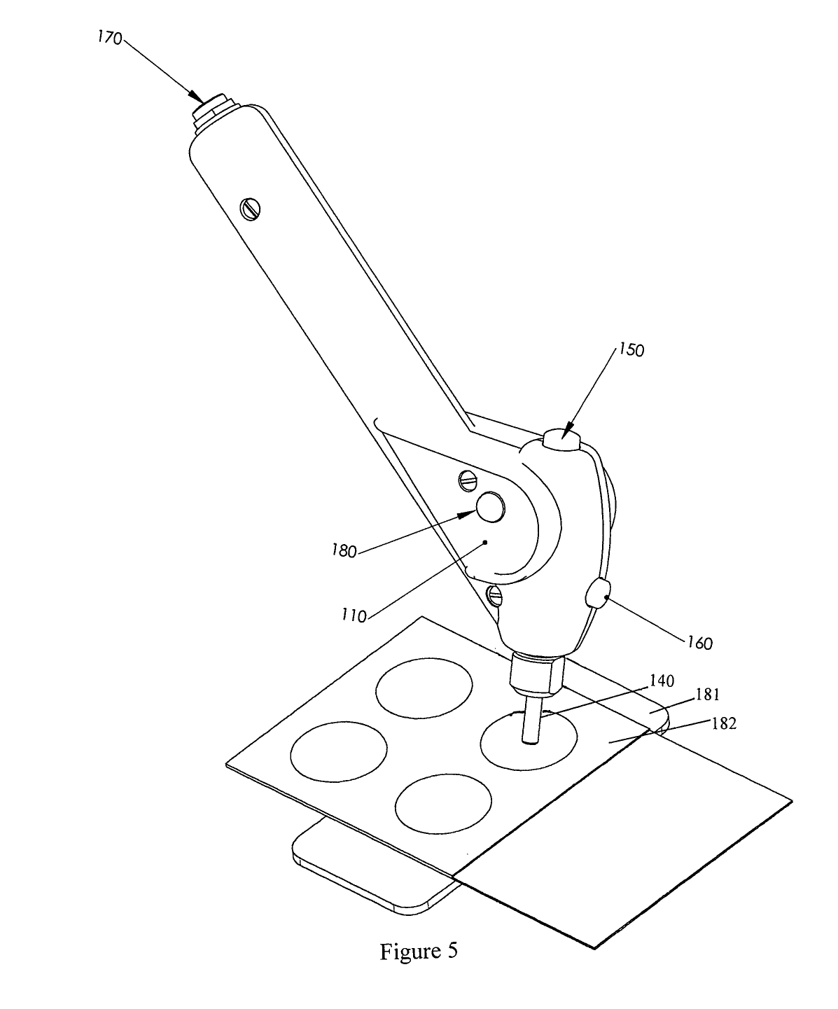

FIG. 5 is a perspective view of the apparatus with tubular cutting sleeve 140 resting on top of a blood card 181 to be sampled. The blood card 181 rests on top of a cutting mat 182. The push button switch 180 is depressed to activate the motor 200 which rotates the tubular cutting sleeve 140. Downward pressure is applied and a sample is cored from the blood card 181.

FIG. 6 is a side view of the apparatus along sectional line 1-1 without spindle lock button 160 and with the ejection rod 300 in the retracted stowed position.

FIG. 6A is an enlarged cross-sectional view of FIG. 6 of the apparatus taken along the sectional line 1-1 showing details of the sample ejection system in the retracted position. The eject rod 300 is attached to push-button 150, which is biased towards the retracted position by spring 270. A sample 400, having been cut as described above, is shown temporarily lodged in the end of the sample sleeve 140. Also shown is the collet sleeve clamping system compromising: the collet spindle 250 that radially clamps the external diameter of the sample sleeve 140 when collet nut 130 is tightened. A plurality of collets may be provided to suit a plurality of different diameters of tubular cutting sleeves.

FIG. 6B is a side view of the apparatus along section line 2-2 without spindle lock button 160 and with ejection rod 300 in the expulsion position.

FIG. 6C is an enlarged cross-section view of FIG. 6B of the apparatus taken along the sectional line 2-2 showing details of the sample ejection system in the expulsion position. The eject button 150 is shown depressed which causes the eject rod 300 to move axially down the hollow core of the spindle 250. The lower tip of the eject rod 300 then projects beyond the end of the sample sleeve 140 thus ejecting the sample 400 from where it was lodged at the sample sleeve 140 lower extremity.

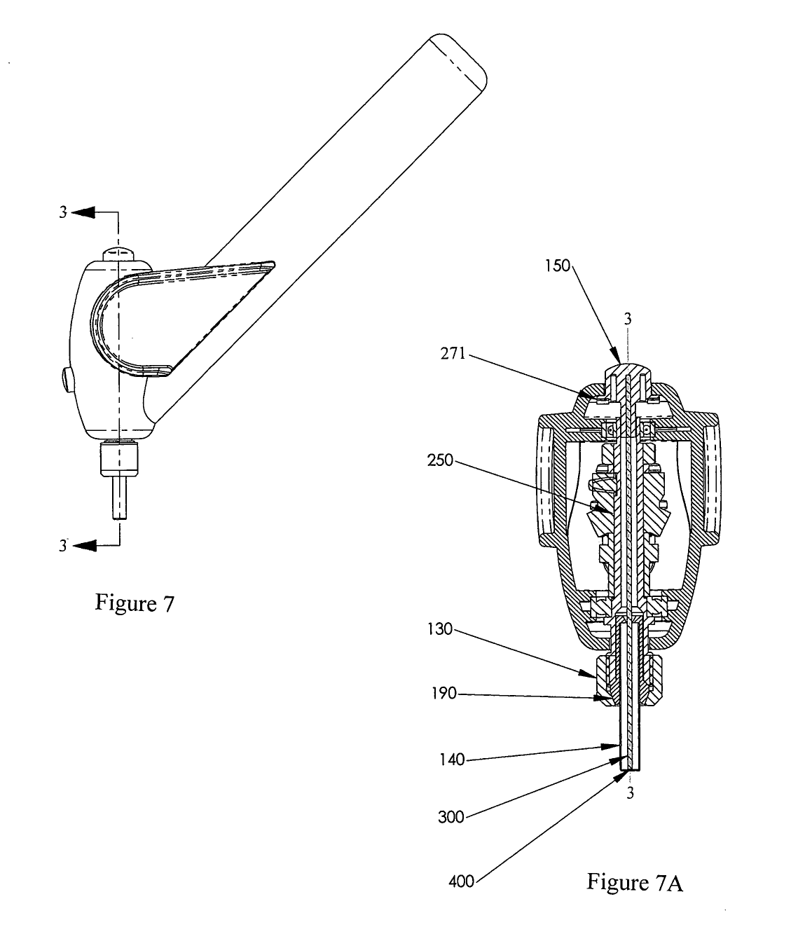

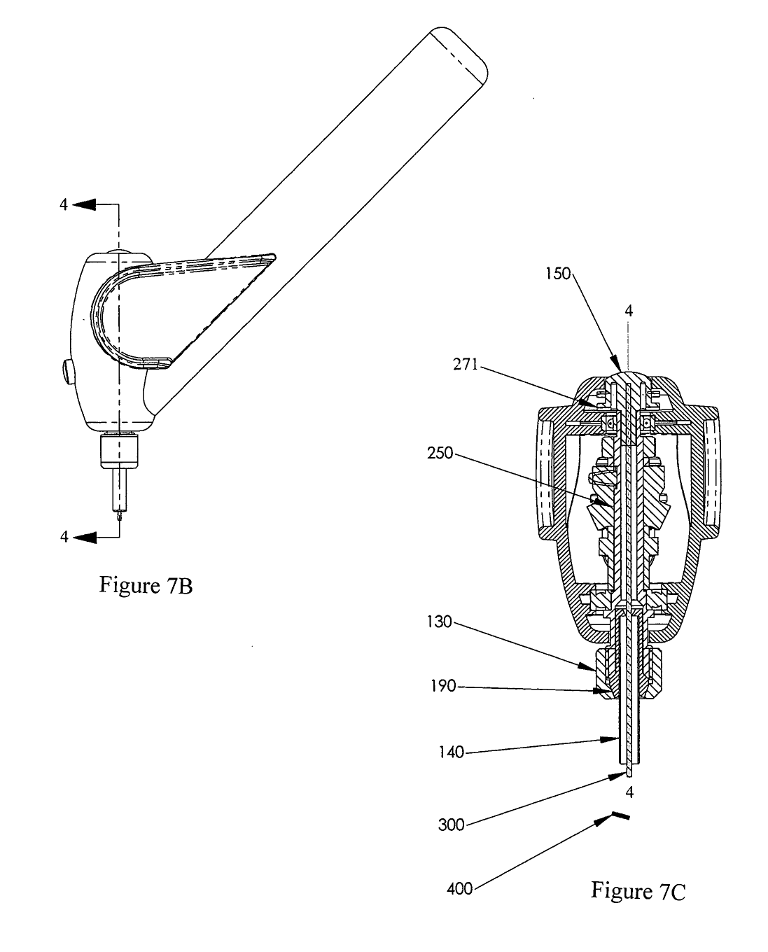

FIG. 7 is a side view of the apparatus along section line 3-3 with spindle lock button 160 and with the ejection rod 300 in the retracted stowed position.

FIG. 7A is an enlarged cross-section view of FIG. 7 of the apparatus taken along the section line 3-3 with the spindle lock button 160 showing details of the sample ejection system in the retracted position. This view repeats the respective described elements for FIG. 6A with the only difference being the leaf spring 271 for the eject button 150 which is biased towards the retracted stowed position. In FIG. 6A push-button 150 is biased towards the retracted position by spring 270.

FIG. 7B is a side view of the apparatus along section line 4-4 with the spindle lock button 160 and with ejection rod 300 in the expulsion position.

FIG. 7C is an enlarged cross-section view of FIG. 7B of the apparatus taken along the section line 4-4 with the spindle lock button 160 showing details of the sample ejection system in the expulsion position. This view repeats the respective described elements for FIG. 6B with the only difference being the leaf spring 271 for the eject button 150 which is biased towards the expulsion position. In FIG. 6B push-button 150 is biased towards the expulsion position by spring 270.

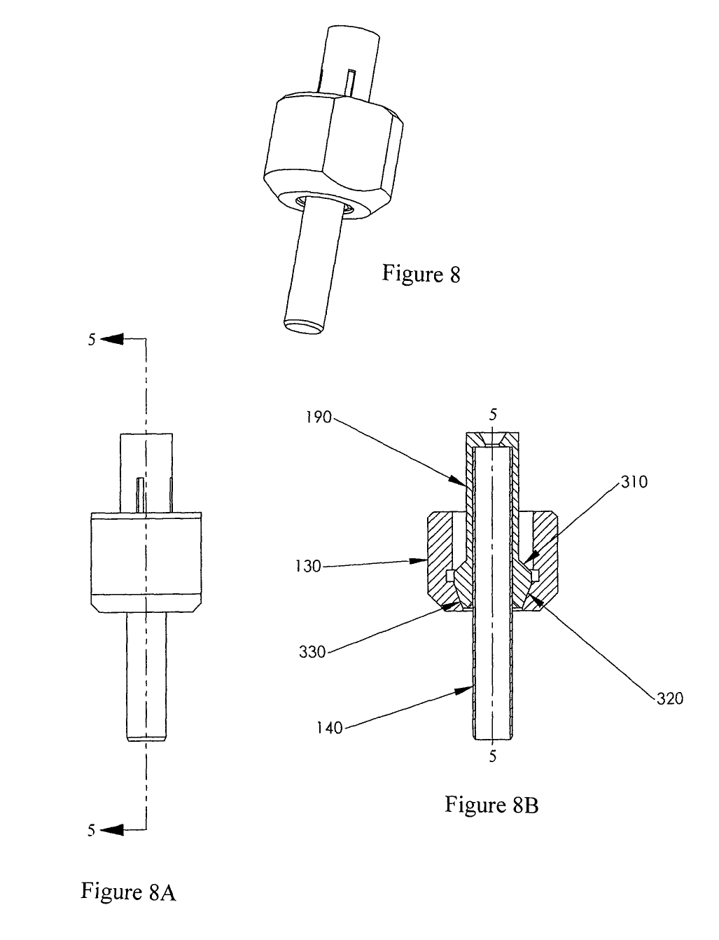

FIG. 8 is a perspective view of the sample sleeve collet system of the apparatus.

FIG. 8A is a side view of the sample sleeve collet system of the apparatus along section line 5-5.

FIG. 8B is a cross section view of the sample sleeve collet system of the apparatus along sectional line 5-5 from FIG. 8A. The collet 190 has two conical faces where the upper face 310 contracts a corresponding internal conical face on the collet spindle 250 (not shown). Similarly the lower conical face 320 on the collet contacts a corresponding internal conical surface of the collet nut 130. Axial slots in the collet allow the jaws 330 to flex radially. When the collet nut 130 is tightened against the spindle 250 the axial movement between them causes the conical faces to slide against each other to reduce the jaw diameter and thus clamp the tubular cutting sleeve 140 within the collet 90. To release or tighten the collet nut 130 it is necessary to provide resistance to rotational movement of the spindle 250. One method to accomplish this is by inserting a dead jack into socket 170. When the push button switch 180 is depressed it converts the armature into a dynamo, thereby shorting the armature windings of the motor 200, resulting in a braking effect. This allows the collet nut 130 to be removed with finger pressure or with aid of a wrench.

A preferred embodiment of this invention is the ergonomic design accomplished by the use of mitre gears 240 in FIGS. 3A and 3B. This gear arrangement has allowed the device to be constructed such that it is ergonomically sculpted to be held in either hand, in a comfortable position with the horizontal boss 100 (also clamshell casing) resting along the bridge between the thumb and index finger. This handling arrangement mimics that used to hold a conventional writing instrument and is therefore familiar to the operator when holding the invention for the first time. The device does not feel foreign to use as it models after the position of the writing instrument.

Another preferred embodiment also arising from the mitre gears 240 arrangement is the reduced rotation of the motor 200. The torque of the motor 200 has been reduced thereby reducing the rpm and the rotation. This reduction in rotation reflects the speed used with manual coring tools designed for the same application. As the motor speed is reduced there is less vibration translated through the hand during the holding and operation of the device. This reduces shock to the hand which may result in the tensing of the hand from vibration affecting the hand muscles.

Still another preferred embodiment also arising from the mitre gears 240 arrangement in FIG. 3A and 3B is the positioning of the push button switch 180 which enables single hand use for both activation of the motor 200 and ejection of the sample 400 by depressing ejection button 150.

A preferred embodiment is the adoption of a motor 200 to rotate the cutting tip. This eliminates the use of a manual coring tool for extended long period use for a large numbers of samples. The use of a manual sampling tool in the past has resulted in related RSI injury due to lateral and vertical repeated movement of the wrist to operate the tool to sample source material. The motorized rotation of the tubular cutting sleeve 140 allows for high throughput sampling and continual use of the device without interruptions or stoppages. Consequently there is a reduced contribution of strain to the technician's hand which is common with the manual coring tool.

Another preferred embodiment is the adoption of a dead jack which is inserted into socket 170. When this dead jack is inserted into the socket 170 and the side trigger button 180 depressed, the armature is shorted thereby converting the motor 200 to a generator/dynamo. This results in a braking action of the collet spindle 250. When this occurs the collet nut 130 may be loosened for removal of the collet 190 to replace tubular cutting sleeves 140. This replaces, but does not preclude, the use of a front mounted spindle locking button 160 which is also designed to brake or lock the collet spindle 250. Either of these locking or braking devices holds the collet spindle 250 allowing for the collet nut 130 to be loosened for replacement of the tubular cutting sleeve 140. The collet nut 130 may also be loosened with the aid of a small wrench.

Another preferred embodiment is the universal size collet 190 and ejection rod 300 which allows for a plurality of different diameter tubular cutting sleeves 140 to be used on the same unit.

Another preferred embodiment is the combined sharp cutting edge and coring action of the tubular cutting sleeve 140. This is consistent with that of the manual coring devices and eliminates cross contamination between samples. Elimination of cross contamination occurs due to the cutting edge of the tubular cutting sleeve 140 combined with the coring actions which does not shear when extracting a sample, and therefore does not tear the sample, as is common with conventional paper punching devices. Therefore no artefact fibres are created and there is no carry over between samples.

Another preferred embodiment is the variable length of the tubular cutting sleeve 140 which can be accommodated in the collet 190 thereby allowing for ejection of sample into deep vials or for extraction of sample source materials which may be hard to access.

Another preferred embodiment is the location of the ejection rod 300 down the centre of the collet spindle 250 thereby allowing for the ejection operation of the stored sample from the cutting sleeve 140. No other electric punching device operates with this combined coring, sample storage, and ejecting system.

Another preferred embodiment is the use of the spring 270 to bias the ejection rod 300 in the stowed position. When ejection is necessary this can be rapid, for quick release of sample 400 in high throughput situations. Alternatively the ejection may be slower for gradual release and careful positioning of sample 400 onto sample stages.

Another preferred embodiment arising from the motorized rotation of the tubular cutting sleeve 140 is that less downward force is required to be applied than is otherwise needed for the manual coring device to cut through the paper sample. The constant circular rotation cuts into the sample with minimal downward pressure required to excise a sample. The motorized rotation cuts into the sampling media with minimal downward pressure.

Still another preferred embodiment arising from the motor 200 rotation is that the motorized coring device allows for thicker substrates to be sampled without creation of artefact fibres. This increases the versatility of this sampling tool over manual tools which would necessitate increased downward pressure and possibly increase the likelihood of RSI to the wrist.

Still another preferred embodiment is the incorporation of a battery operated power supply with a recharging system for cordless use.

Still another preferred embodiment is the reduced number of moving parts and therefore reduce or eliminated generation of static commonly associated with large, multi-component bench top punching systems. With little or no static and no artefact fibres, the potential for cross contamination between samples is virtually eliminated.

The present embodiments allow the sample 400 to be ejected from tubular cutting sleeve 140 in its entirety into a receptacle without manually working sample 400 free from tubular sleeve 140. The sample 400 is cut and retrieved in a single, simultaneous step, without use of tweezers to lift sample 400 after extraction. The sample 400 can be ejected in a rapid or slow manner which may be of value for selected tissue substrates.

As shown in FIG. 1A the sample taking device is comprised of a blended vertical boss 120, a tubular cutting sleeve 140, plunger 300, clamshell cover 100, motor 200. Motor 200 is used to rotate tubular cutting sleeve 140 to core a sample 400 from a substrate 181, which is held within the tubular cutting sleeve 140, which is ejected by ejection rod 300 when push button 150 is depressed.

The design of a sample taking device in FIG. 1A is such that it is balanced with a center of gravity located in the horizontal boss 100 (clamshell casing) resting in the fork of the bridge area between thumb and index finger. The wrist is maintained in a straight position with no movement and the hand grasps the vertical blended boss 120 to lift and lower the unit for cutting. Therefore there is minimal repetitive stress in the wrist as is common with the prior art, manual coring devices.

1. An electric apparatus to collect a sample comprising:
a tubular clamshell casing at an angle to the horizontal;
a blended tubular boss extending from the clamshell casing;
a tubular cutting sleeve extending downward from the boss, the distal end of the cutting sleeve forming a cutting edge circumscribing a circular region;
an ejection rod sliding reciprocally from a stowed position within the tubular sleeve past the cutting blade into an expulsion position;
an electric motor within the clamshell casing which drives, via gears, the sample cutting sleeve in a rotational manner;
an actuator means to actuate said plunger from the stowed position to the expulsion position;
a collet to hold different diameter cutting sleeves;
a spindle locking system for removal of sample collet system to replace or change cutting tip and/or ejection rod;
a dead jack for insertion into socket at distal end of horizontal tubular handle (horizontal clamshell) to short armature, converting to dynamo when trigger button is depressed, providing braking effect to remove sample collet system;
fluted ribbing running parallel along horizontal tubing and blended boss;
finger rails or ledges to rest fingers and grip boss, non-handed;
two mitre gears within blended boss allow for ergonomic design and reduced torque and reduced translational vibration to the hand, and;
ergonomically designed clamshell casing sculpted to the hand to reduce or eliminate repetitive stress injury.

2. The apparatus of claim 1 further including biasing means to bias said plunger in said stowed position.

3. The apparatus of claim 1 wherein said actuator means comprises a button positioned at the top of the blended boss from the horizontal. This button is operated under a spring action to bias the plunger to the stowed position.

4. The apparatus of claims 1, 2 and 3 wherein said actuator means comprises a button positioned at the top of the blended boss from the horizontal. This button is operated under a spring and when depressed biases the plunger to the expulsion position. This plunger travels through the hollow of the collet spindle.

5. The apparatus of claim 1 having a horizontal tubular design and to be held similar to a large pen or felt tip marker, balanced with its center of gravity located along it horizontal portion resting on the fork (bridge) between thumb and index finger. The blended boss is gripped by the entire hand and not just the fingers, thereby reducing hand and wrist strain.

6. The apparatus in claim 1 having a motor to rotate the cutting blade thereby requiring no wrist movement to rotate the cutting tip, allowing the wrist to remain in a neutral (straight) position. This reduces or eliminates repetitive stress injury a common complaint with prior art manual coring tools.

7. The apparatus in claims 1, 5 and 6 having mitre gears which allow for the ergonomic design of tubular horizontal boss and blended boss to be sculpted to the hand and to rest comfortably in fork between thumb and index finger similar to a large diameter pen.

8. The apparatus in claims 1 and 7 having an ergonomic design such that the entire hand grasps the blended boss and not just the fingers of the hand as occurs in the prior art. The entire hand holds unit and not just fingers, therefore less repetitive stress.

9. The apparatus in claims 1, 5, 6 and 7 includes a motor and mitre gears which torque down motor rpm reducing vibration and translation of vibration to hand. This reduces strain on hand.

10. The apparatus in claim 1 wherein the motor may be activated either by a push button located on the side of the blended boss or alternatively by applying downward pressure and contact of the cutting edge of the tubular cutting sleeve with the sample to be cut.

11. The apparatus in claim 1 wherein the collet system is designed to accommodate a plurality of different diameter tubular cutting tips.

12. The apparatus in claims 1 and 11 wherein the length of the tubular cutting tips may be varied to sample materials in deep collecting receptacles such as micro-titre plates, or to sample source material at hard to reach locations. The versatile accommodation of the extended length of the cutting tips also allows for positioning of sample on preferred sampling stages or depositing deep within a collection vial.

13. The apparatus in claims 1, 6 and 10 wherein the motorized rotation of the tubular cutting tip allows for thicker samples to be collected than otherwise sampled with a manual coring tool.

14. The apparatus in claims 1, 6, 10, 11, and 13 wherein the motor and razor sharp edge of tubular cutting tip allow this device to be used for high throughput sampling of large volumes of blood cards, for instance, while reducing RSI.

15. The apparatus in claims 1, 4, 11, 12, 14 and 13 wherein the tubular cutting tip enables the operator to place the tip directly in the vial or plate well and to view the sample following delivery. This device offers an alternative to automated systems, eliminates the cross contamination that may occur and ensures correct transfer of sample to appropriate collection vial.

16. The apparatus in claims 1, 6, 11, 13 and 14 wherein the razor sharp edge of tubular cutting tip enables this device to sample a variety of thick, composite paper substrates without the creation of artefact remnant threads which could lead to cross contamination. This cross contamination can occur with automated punching systems which, through the design of the punch, shear the paper sample to be extracted, thereby creating fibre artefacts and do not cut the sample as in the case with the present invention.

17. The apparatus in claims 1, 6, 11, 13 and 14 wherein the razor sharp edge of tubular cutting tip enables this device to sample a variety of substrates at any location on the surface and is not restricted by the surface area of the substrate. Unlike automated systems which are restricted to surface areas not exceeding dimensions to be accommodated in the throat of the automated punch.

18. The apparatus in claims 1, 6, 11, 13 and 14 wherein the razor sharp edge of tubular cutting tip enables this device to sample a variety of substrates beyond blood cards for which the automated systems are specifically designed. This invention may sample a variety of media beyond blood cards and including, but not limited to, leaf samples, plastic substrates, human and animal tissue.

19. The apparatus in claims 1, 6, 11, 13 and 14 wherein the razor sharp edge of tubular cutting tip enables this device to sample the same substrate several times and to collect the sample continuously for large sampling to be delivered to a single vial. Bench top systems punch samples, may not deliver such samples as desired, may generate artefacts and result in cross contamination.

20. The apparatus in claims 1 and 12, 13, 14, 15 wherein the design of the unit for electric coring is such that it is designed to ensure the cored sample is deposited in a preferred collecting vial or location. Length of tubular cutting tip allows for placement and seating of sample in base of deep collecting vessels when sample is ejected. Such positioning is not always possible when dealing with automated systems that are left unattended. Automated systems may accidentally, or due to static build-up, result in more than one sample adhering to the wall of the delivery column, and therefore not reaching the collection vessel, or reaching the collection vessel but not properly seated in the vessel. This can result in loss of sample from the vessel and potential cross contamination.

21. The apparatus in claim 1 wherein a spindle locking mechanism may be activated to lock the spindle for removal of the collet nut and access to the tubular cutting sleeves.

22. The apparatus in claims 1 and 17 wherein a dead jack may be inserted into the socket at the distal end of the horizontal tubular boss which will short the armature causing a braking action to allow for removal of the collet nut and access to replace the tubular cutting sleeve.

23. The apparatus in claims 1 and 11 wherein this device allows for a single unit with consumable tubular cutting tips of variable diameters and lengths.

24. The apparatus in claims 1 and 7, 8, 9 wherein the apparatus is ergonomically designed such that either hand can comfortably use the unit again reducing RSI by allowing for the option of using alternate hands.

25. The apparatus in claims 1 and 12, 13, 14, 15 wherein the sharp cutting tip and design of the unit for electric coring results in clean, artefact free samples being extracted. The absence of paper fibres (paper) or other artefacts (i.e. plant tissue) reduces the cleaning cycle between sample extractions.

26. The apparatus in claims 1, 5, 6 and 7 includes a motor of design and size to keep the unit light and requiring less effort and strain to move when operating thereby reducing RSI.

27. The apparatus of claims 1, 2, 3, 4 and 111 wherein said actuator means comprises a button positioned at the top of the blended boss from the horizontal. This button is operated under a spring and when depressed biases the ejection rod to the expulsion position. This ejection rod travels through the hollow of the collet spindle therefore allowing the end of the ejection rod to contact the sample from the rear and eject sample directly through the axial length of the collet spindle.

28. The apparatus of claim 1 wherein there is no associated static electricity generated with this design. The absence of static electricity ensures sample is ejected to desired location. Prior art electric punching units create static electricity which may result in loss of sample or cross contamination.
